(19) United States
(12) Patent Application Publication
(10) Pub. No.: US 2010/0077288 A1
(43) Pub. Date: Mar. 25, 2010

(54) Displaying a Form

(76) Inventors: Asaf Adi, Kiriat Ata (IL); Maya Barnea, Kiriat Bialik (IL); Idan Ben-Harrush, Givat Elah (IL); Nili Ifergan, Kiriat Ata (IL); Samuel Kallner, Menashe (IL); Yoav Rubin, Haifa (IL); Gal Shachor, Yokneam (IL)

Correspondence Address: IBM CORPORATION, T.J. WATSON RESEARCH CENTER, P.O. BOX 218, YORKTOWN HEIGHTS, NY, 10598, US

(21) Appl. No.: 12/234,726

(22) Filed: Sep. 22, 2008

(51) Int. Cl. G06F 17/00

(52) U.S. Cl. 715/221

(57) ABSTRACT

A method for displaying a form, the method includes: displaying a form that comprises a first field that is partially hidden; and controlling a status of the first field in response to first field status control information; wherein the status is selected from a group consisting of fully hidden, partially hidden, fully viewable and deleted.

### FIELD OF THE INVENTION

The present invention relates to systems, methods and computer program products for displaying a form.

### BACKGROUND OF THE INVENTION

Forms can include many fields. These fields are usually filled by a user in a sequential manner. Fields that are already filled in or fields that are irrelevant (for some other reason) can be completely hidden. During the form development process the full hiding of fields should be simulated. The full hiding of a field can be implemented by masking the field or by collapsing the field.

Fully hiding fields can have a negative impact on the form development process; especially if during the development process irrelevant fields (that should be fully hidden when the form is used) should be shown so that the developer can be aware that these fields exist.

### SUMMARY

A method for displaying a form, the method includes: displaying a form that comprises a first field that is partially hidden; and controlling a status of the first field in response to first field status control information; wherein the status is selected from a group consisting of fully hidden, partially hidden, fully viewable and deleted.

### BRIEF DESCRIPTION OF THE DRAWINGS

The present invention will be understood and appreciated more fully from the following detailed description taken in conjunction with the drawings in which:

FIG. 1 illustrates a system, according to an embodiment of the invention;

FIG. 2 illustrates a method, according to an embodiment of the invention;

FIG. 3 illustrates a method, according to an embodiment of the invention;

FIG. 4 illustrates a method, according to an embodiment of the invention;

FIG. 5 illustrates a method, according to an embodiment of the invention; and

FIG. 6 illustrates a form at different points in time, according to an embodiment of the invention.

### DETAILED DESCRIPTION OF THE DRAWINGS

A method, system and computer program product for displaying a form are provided. The form can include at least one partially hidden field. Additionally or alternatively, the status of at least one field can be controlled by field status control information.

A field can be fully hidden, partially hidden, fully viewable or deleted. By controlling the status of such a field the amount of information that is displayed to a user at any given point in time can be set. This can assist in preventing users from being overwhelmed by information and clutter and yet enables a user to alter the status of one or more fully hidden, partially hidden or fully viewable fields.

A fully viewable field can be updated. A partially hidden field is visible but its content is less visible than those of the fully viewable field. For example, at least one character is masked, one or more characters of the partially viewable field can be characterized by a low intensity, can have a different color than characters of the fully viewable field, can be smaller than characters of a fully viewable fields, can be displayed with a low intensity. Additionally or alternatively, the background of the partially viewable field can be selected so as to provide a low contrast between the background and at least one character of the partially viewable field. The contrast can be lower in relation to the contrast between characters of a fully viewable field and their background. Additionally or alternatively, the fonts can be different.

The status of a fully viewable field, a partially hidden field and a fully hidden field can be changed.

Field status control information can be provided in various manners. For example, it can be received from a user after displaying (to the user) field status selection information that facilitates a selection of a next status of the field, and receiving field status control information indicative of the selection. The field status selection information can be presented when a cursor of the user hovers over the field, hovers in the vicinity of the field or hovers over another predefined location. Additionally or alternatively, field status selection information can be displayed at predetermined points in time or in response to events that differ from a hovering of a cursor over a predefined location.

Conveniently, the selection can be made by pressing a button, clicking on a link, moving the mouse, touching a screen, and the like.

Field status control information can be generated so as to reflect a desired status of the field. The desired status can reflect an estimated or an actual user preference.

The user preference can be estimated in response to one or more of the following: (i) previous status selection operations of the user, (ii) actions (such as status selections) of other users, (iii) user behavior patterns, and the like.

For example, a certain user may prefer that a field is partially hidden for a certain period after updating the field and then it is fully hidden. Yet for another example, the user can prefer that a field remains fully viewable until the user fills in all fields within a certain portion of the form or related fields. Yet for a further example, if a user repetitively changes the status of partially hidden fields to fully viewable status then partially viewable fields should be converted to fully viewable fields.

The status of fields can be determined by simulating the form visibility (especially the status of each field of the form) during a workflow. For example, if certain fields are filled in before other fields, the other fields can be at least partially hidden until the certain fields are filled and the certain fields can be at least partially hidden after being filled in.

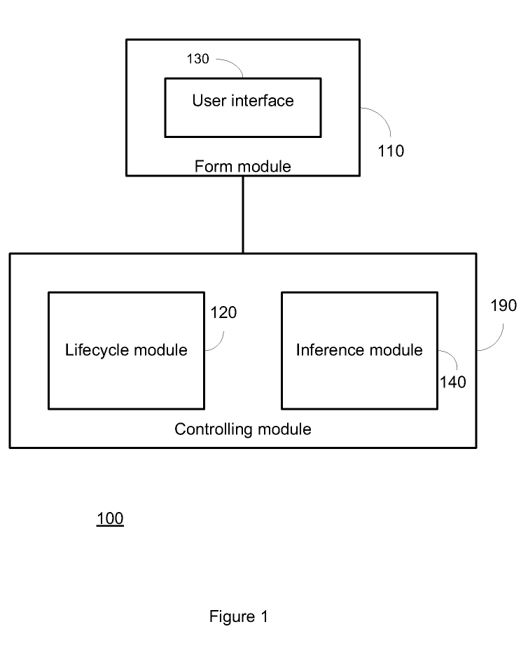

FIG. 1 illustrates system 100 according to an embodiment of the invention.

System 100 can execute any of the mentioned below methods or a combination thereof. System 100 can execute a combination of any stages of the mentioned above methods.

System 100 includes form module 110 and controlling module 190. Controlling module 190 includes at least one module out of lifecycle module 120 and from inference module 140. Each module can include software, hardware, middleware or a combination thereof.

System 100 can be implemented by a computer that executes software that is stored on a computer readable medium so as to implement any of the mentioned below methods or a combination thereof.

Form module 110 can be a form development module, a form based application, a form processing module and the like. It can control the state of fields of a form, wherein possible states are fully viewable, fully hidden, partially hidden or deleted. Form module 110 can control a display of fields of the form at any given point in time in response to field status control information.

Field status control information can be provided from various modules. It can be provided from lifecycle module 120, from user interface 130 or from form inference module 140.

Lifecycle module 120 can define a form lifecycle that determines what the status of fields of the form will be during each period of time (out of multiple periods of time). Additionally or alternatively, lifecycle module 120 can define a form lifecycle that determines which events shall trigger a change in the status of fields of the form.

Lifecycle module 120 can also manage the lifecycle by sending form module 110 the field status control information that matches the lifecycle.

Conveniently, when a form is defined, the lifecycle module can define or receive the form lifecycle. In-between invocations, the status of the various fields of the form can be saved in a database.

Form module 110 can include user interface 130 that can perform at least one of the following: (i) cause field status selection information to be displayed in response to predefined events; (ii) receive a selection of a user that is responsive to a display of field status selection information. For example, a form processing module can overlay one or more fields with an appropriate user interface that allows a user to change the status of a field. For example, when using AJAX based technologies as a form rendering layer, additional “HTML” tags can be added in locations relative to the field. The form processing module can present these additional controls whenever a user pointing device hovers over the field. The user pointing device can be tracked by using DOM event handlers.

Inference module 140 can estimate a desired state of a field. It can be responsive to user provided data to deduce how a form should be presented.

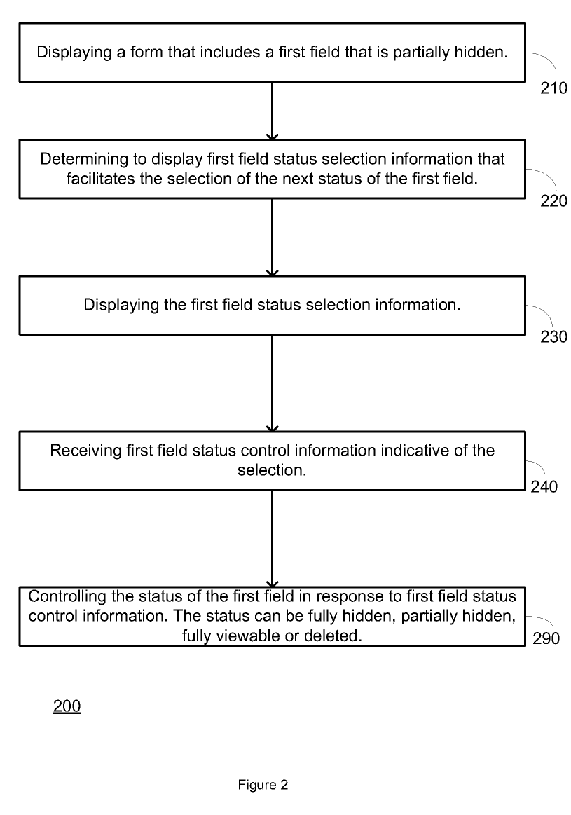

FIG. 2 illustrates method 200 according to an embodiment of the invention.

Method 200 starts by stage 210 of displaying a form that includes a first field that is partially hidden. The form can include more than a singe field that is partially hidden. This first field is termed “first” only in order to differentiate it from other fields of the form.

Stage 210 is followed by stage 220 of determining to display first field status selection information that facilitates a selection of the next status of the first field. Stage 220 can be triggered by the hovering of a cursor over a predefined location such as but not limited to the first field, the vicinity of the first field or another location. The cursor is associated with a user pointing device such as but not limited to a mouse, a light pen, a keyboard.

Stage 220 is followed by stage 230 of displaying the first field status selection information.

Stage 230 is followed by stage 240 of receiving first field status control information indicative of the selection. Stage 240 is followed by stage 290 of controlling the status of the first field in response to first field status control information. The status can be fully hidden, partially hidden, fully viewable or deleted.

Method 200 can also include a stage of printing the form.

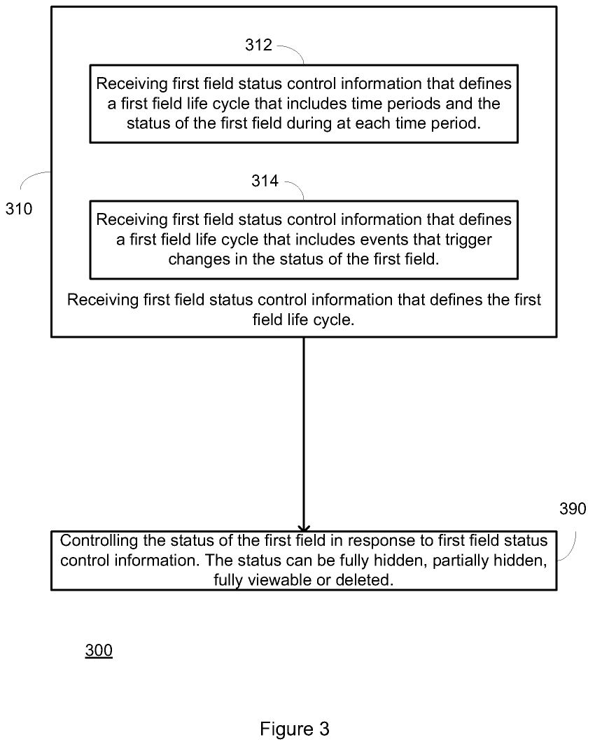

FIG. 3 illustrates method 300 according to an embodiment of the invention.

Method 300 starts by stage 310 of receiving first field status control information that defines a first field life cycle.

Stage 310 can include stages 312 and, additionally or alternatively, stage 314.

Stage 312 includes receiving first field status control information that defines a first field life cycle that includes time periods and the status of the first field during at each time period.

Stage 314 includes receiving first field status control information that defines a first field life cycle that comprises events that trigger changes in the status of the first field.

Stage 310 is followed by stage 390 of controlling the status of the first field in response to first field status control information. The status can be fully hidden, partially hidden, fully viewable or deleted.

Method 300 can include a stage of printing the first field.

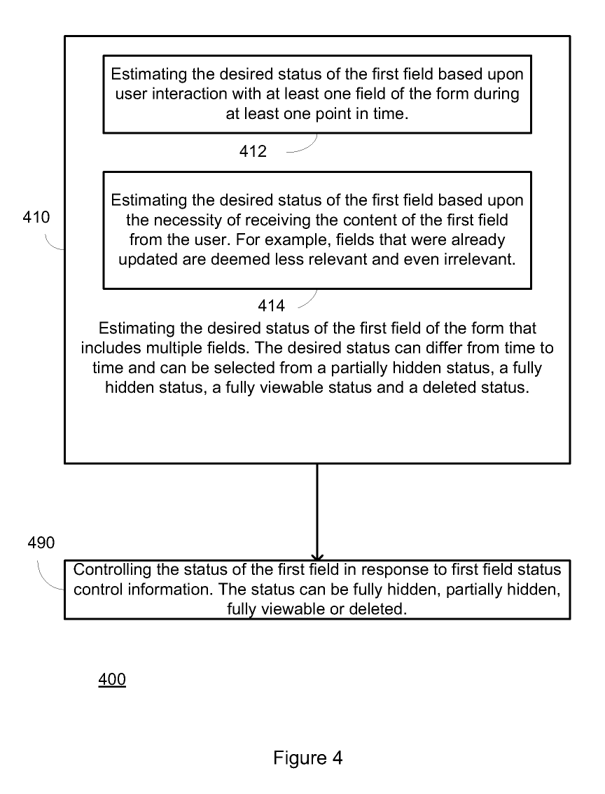

FIG. 4 illustrates method 400 according to an embodiment of the invention.

Method 400 starts by stage 410 of estimating the desired status of a first field of a form that includes multiple fields. The desired status can differ from time to time and can be selected from a partially hidden status, a fully hidden status, a fully viewable status and a deleted status.

Stage 410 can include stages 412 and, additionally or alternatively, stage 414.

Stage 412 includes estimating the desired status of the first field based upon user interaction with at least one field of the form during at least one point in time.

Stage 414 includes estimating the desired status of the first field based upon a necessity of receiving the content of the first field from a user. For example, fields that were already updated are deemed less relevant and even irrelevant.

Stage 410 is followed by stage 490 of controlling the status of the first field in response to the estimation.

Method 400 can also include a stage of printing the first field.

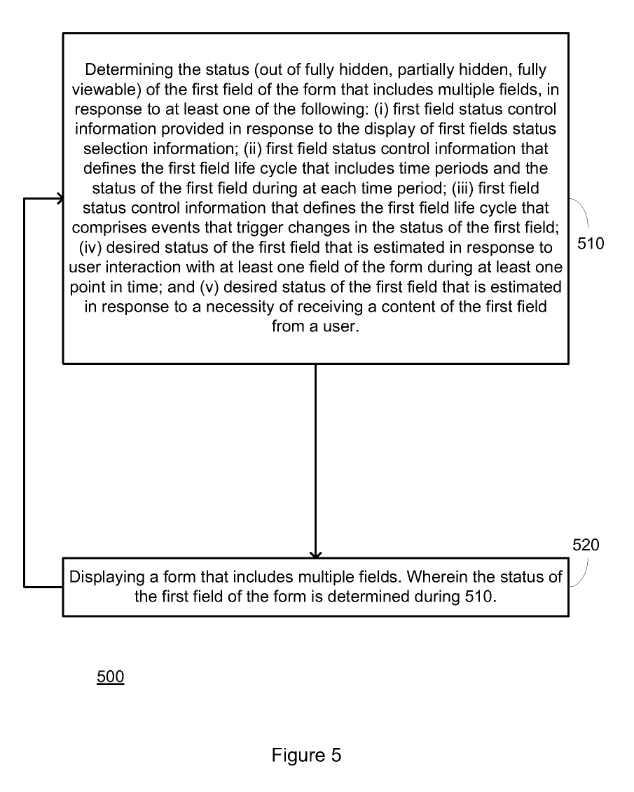

FIG. 5 illustrates method 500 according to an embodiment of the invention.

Method 500 starts by stage 510 of determining the status (out of fully hidden, partially hidden, or fully viewable) of a first field of a form that includes multiple fields, in response to at least one of the following: (i) first field status control information provided in response to a display of first field's status selection information; (ii) first field status control information that defines a first field life cycle that includes time periods and the status of the first field during each time period; (iii) first field status control information that defines a first field life cycle that comprises events that trigger changes in the status of the first field; (iv) desired status of the first field that is estimated in response to user interaction with at least one field of the form during at least one point in time; and (v) desired status of the first field that is estimated in response to the necessity of receiving the content of the first field from a user.

Stage 510 is followed by stage 520 of displaying a form that includes multiple fields. Wherein the status of a first field of the form is determined during stage 510. Stage 520 is followed by stage 510.

Method 500 can also include a stage of printing the form.

Either one of methods 200, 300, 400 and 500 provides a tangible result. For example either one of these methods can include printing a field or a page, can include altering a design of a form that will be printed in the future, and the like.

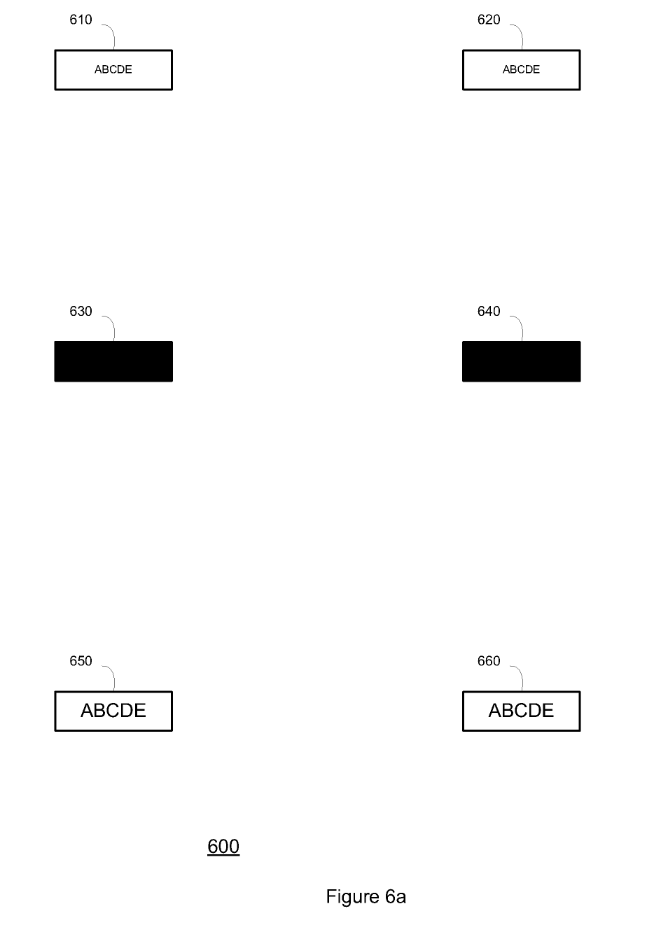

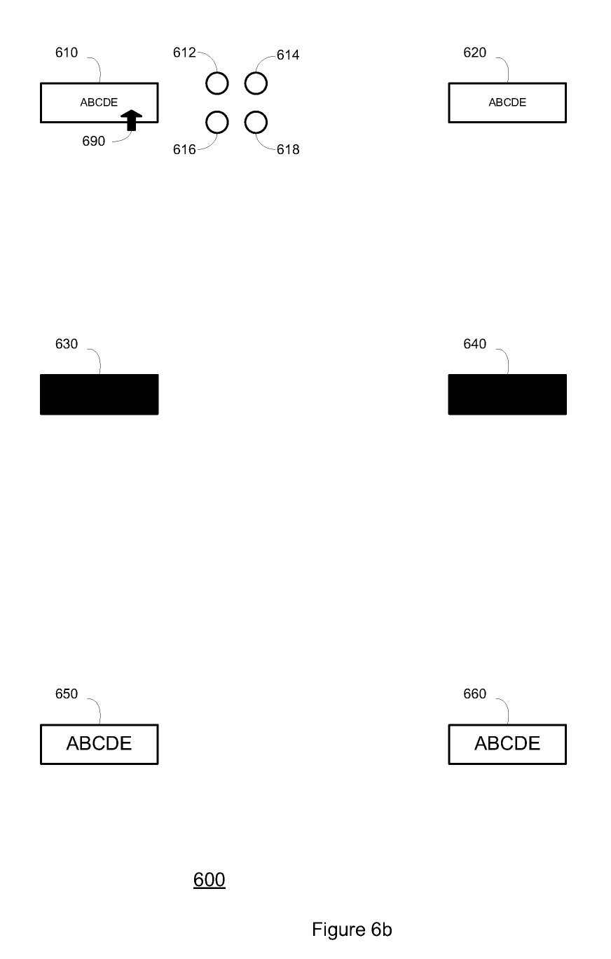

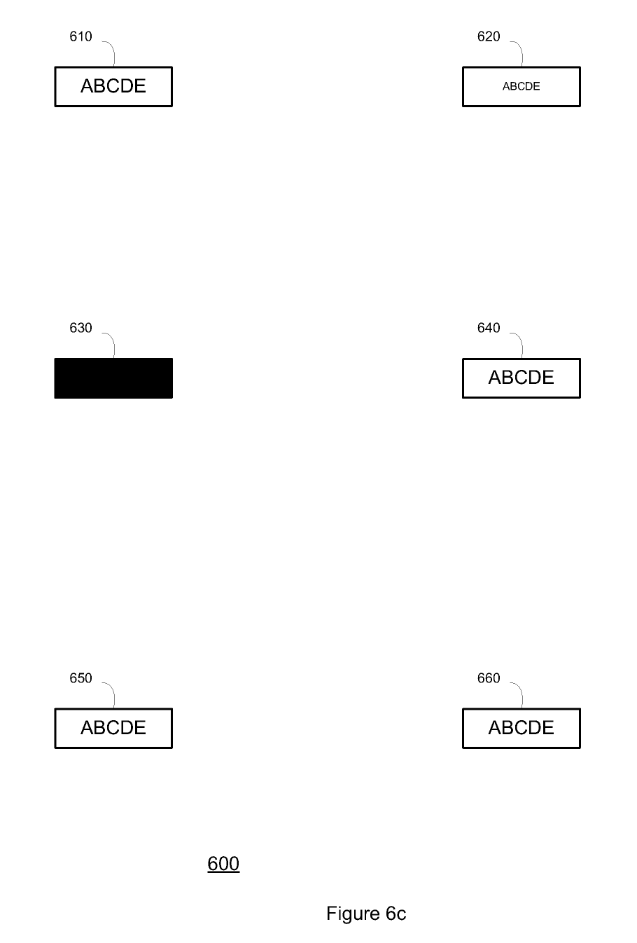

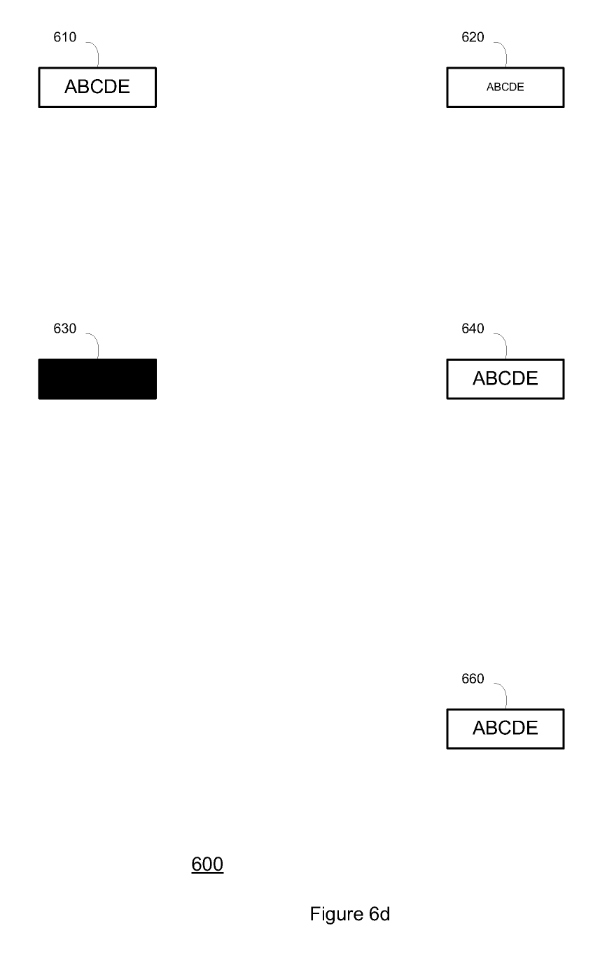

FIGS. 6a-6d illustrate form 600 at different points in time, according to an embodiment of the invention.

FIG. 6a illustrates form 600 at a first point in time T1. Form 600 includes partially hidden fields 610 and 620, fully hidden fields 630 and 640 and fully viewable fields 650 and 660. Conveniently, partially hidden field includes smaller characters than those of fully viewable fields 650 and 660 and fully hidden fields 630 and 640 are masked—as illustrated by the two black boxes 630 and 640.

FIG. 6b illustrates form 600 at a second point in time T2. At T2 cursor 690 of a user hovers over partially hidden field 610, and in response four buttons 612, 614, 616 and 618 are displayed—button 612 represents a fully viewable status, button 614 represents a partially hidden status, button 616 represents a fully hidden status and button 618 represents a deleted status. These buttons are field status selection information.

Assuming that the user selected button 612 then the status of field 610 will turn to be fully viewable. This fully viewable state of field 610 is illustrated in FIGS. 6c and 6d.

FIG. 6c illustrates form 600 at another point in time T3. At T3 field status control information that defines a life cycle of fully hidden field 640 causes it to turn fully viewable.

FIG. 6d illustrates form 600 at a further point in time T4. Just before T4, a user deletes field 650 so that in T4 form 600 does not include field 650.

Furthermore, the invention can take the form of a computer program product accessible from a computer-usable or computer-readable medium generating program code for use by or in connection with a computer or any instruction execution system. For the purposes of this description, a computer-usable or computer readable medium is a tangible medium that can be any apparatus that can contain or store the program for use by or in connection with the instruction execution system, apparatus, or device.

The tangible medium can store information that can be read by electronic, magnetic, optical, electromagnetic or infrared based techniques, or semiconductor system (or apparatus or device). Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which generate temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Conveniently, a computer program product is provided. It includes a computer usable medium including a computer readable program, wherein the computer readable program when executed on a computer causes the computer to: display a form that includes a first field that is partially hidden and control a status of the first field in response to first field status control information. The status is selected from fully hidden, partially hidden, fully viewable and deleted.

Conveniently, the computer program product causes the computer to display first field status selection information that facilitates a selection of the next status of the first field; receive first field status control information indicative of the selection; and control the status of the first field in response to the first field status control information.

Conveniently, the computer program product causes the computer to display the first field status selection information in response to the hovering of a cursor over the first field, wherein the cursor is associated with a user pointing device.

Conveniently, the computer program product causes the computer to control the status of the first field in response to first field status control information that defines a first field life cycle that comprises time periods and the status of the first field during each time period.

Conveniently, the computer program product causes the computer to control the status of the first field in response to first field status control information that defines a first field life cycle that comprises events that trigger changes in the status of the first field.

Conveniently, the computer program product causes the computer to estimate the desired status of the first field based upon user interaction with at least one field of the form during at least one point in time; and control the status of the first field in response to the estimation.

Conveniently, the computer program product causes the computer to estimate a desired status of the first field based upon the necessity of receiving the content of the first field from a user; and control the status of the first field in response to the estimation.

Variations, modifications, and other implementations of what is described herein will occur to those of ordinary skill in the art without departing from the spirit and the scope of the invention as claimed.

Accordingly, the invention is to be defined not by the preceding illustrative description but instead by the spirit and scope of the claims.

We claim

1. A method for displaying a form, the method comprises:
displaying a form that comprises a first field that is partially hidden; and
controlling a status of the first field in response to first field status control information; wherein the status is selected from a group consisting of fully hidden, partially hidden, fully viewable and deleted.

2. The method according to claim 1 comprising:
displaying first field status selection information that facilitates a selection of a next status of the first field;
receiving first field status control information indicative of the selection; and
controlling the status of the first field in response to the first field status control information.

3. The method according to claim 1 comprising displaying the first field status selection information in response to a hovering of a cursor over the first field, wherein the cursor is associated with a user pointing device.

4. The method according to claim 1 comprising controlling the status of the first field in response to first field status control information that defines a first field life cycle that comprises time periods and the status of the first field during at each time period.

5. The method according to claim 1 comprising controlling the status of the first field in response to first field status control information that defines a first field life cycle that comprises events that trigger changes in the status of the first field.

6. The method according to claim 1 comprising:
estimating a desired status of the first field based upon user interaction with at least one field of the form during at least one point in time; and
controlling the status of the first field in response to the estimation.

7. The method according to claim 1 comprising:
estimating a desired status of the first field based upon a necessity of receiving a content of the first field from a user; and
controlling the status of the first field in response to the estimation.

8. A system for displaying a form, the system comprises:
a form module adapted to display a form that comprises a first field that is partially hidden; and
a controlling module adapted to control a status of the first field in response to first field status control information; wherein the status is selected from a group consisting of fully hidden, partially hidden, fully viewable and deleted.

9. The system according to claim 8 wherein the controlling module is adapted to:
cause a display of first field status selection information that facilitates a selection of a next status of the first field;
receive first field status control information indicative of the selection; and
control the status of the first field in response to the first field status control information.

10. The system according to claim 8 wherein the controlling module is adapted to cause a display of first field status selection information in response to a hovering of a cursor over the first field, wherein the cursor is associated with a user pointing device.

11. The system according to claim 8 wherein the controlling module is adapted to control the status of the first field in response to first field status control information that defines a first field life cycle that comprises time periods and the status of the first field during at each time period.

12. The system according to claim 8 wherein the controlling module is adapted to control the status of the first field in response to first field status control information that defines a first field life cycle that comprises events that trigger changes in the status of the first field.

13. The system according to claim 8 wherein the controlling module is adapted to:
estimate a desired status of the first field based upon user interaction with at least one field of the form during at least one point in time; and
control the status of the first field in response to the estimation.

14. The system according to claim 8 wherein the controlling module is adapted to: estimate a desired status of the first field based upon a necessity of receiving a content of the first field from a user; and control the status of the first field in response to the estimation.

15. A computer program product that comprises a computer usable medium that comprises a computer readable program, wherein the computer readable program when executed on a computer causes the computer to:
display a form that comprises a first field that is partially hidden; and
control a status of the first field in response to first field status control information; wherein the status is selected from a group consisting of fully hidden, partially hidden, fully viewable and deleted.

16. The computer program product according to claim 15 that causes the computer to display of first field status selection information that facilitates a selection of a next status of the first field; receive first field status control information indicative of the selection; and control the status of the first field in response to the first field status control information.

17. The computer program product according to claim 15 that causes the computer to cause a display of first field status selection information in response to a hovering of a cursor over the first field, wherein the cursor is associated with a user pointing device.

18. The computer program product according to claim 15 that causes the computer to control the status of the first field in response to first field status control information that defines a first field life cycle that comprises time periods and the status of the first field during at each time period.

19. The computer program product according to claim 15 that causes the computer to control the status of the first field in response to first field status control information that defines a first field life cycle that comprises events that trigger changes in the status of the first field.

20. The computer program product according to claim 15 that causes the computer to estimate a desired status of the first field based upon user interaction with at least one field of the form during at least one point in time; and
control the status of the first field in response to the estimation.
